(19) United States
(12) Patent Application Publication
(10) Pub. No.: US 2022/0391788 A1
(43) Pub. Date: Dec. 8, 2022

(54) CONSTRUCTING METHOD ON INTELLIGENT NETWORKED MANUFACTURING MODE WITH HUMAN-CYBER-PHYSICAL COLLABORATION AND FUSION FOR NON-FERROUS METAL INDUSTRY

(71) Applicant: TONGJI UNIVERSITY, Shanghai (CN)

(72) Inventors: Qing LIU, Shanghai (CN); Zichun WANG, Shanghai (CN); Min LIU, Shanghai (CN); Jingwei WANG, Shanghai (CN)

(73) Assignee: TONGJI UNIVERSITY, Shanghai (CN)

(21) Appl. No.: 17/401,283

(22) Filed: Aug. 12, 2021

(30) Foreign Application Priority Data
Jun. 7, 2021 (CN) 202110633536.7

(51) Int. Cl. G06Q 10/06; G05B 13/02; G05B 13/04; G06Q 50/04

(52) U.S. Cl. CPC G06Q 10/067; G06Q 10/06315; G05B 13/027; G05B 13/04; G06Q 50/04

(57) ABSTRACT

The present invention relates to a constructing method on the intelligent networked manufacturing mode with human-cyber-physical collaboration and fusion for a non-ferrous metal industry. According to transformational requirements of a non-ferrous metal industry, production and manufacturing activities are guided by constructing an intelligent manufacturing system with human-cyber-physical collaboration and fusion, an ecosystem service platform, and a sustainable business model. The intelligent manufacturing system with human-cyber-physical collaboration and fusion includes a device autonomous control system and a remote management analysis and decision-making system based on a new generation of AI. The device autonomous control system has functions of perception, intelligent analysis and decision-making, and intelligent control. The remote management analysis and decision-making system has functions of ubiquitous perception, real-time analysis, independent decision-making, and learning improvement.

### CROSS-REFERENCE TO RELATED APPLICATION

This application claims the priority benefit of China application serial no. 202110633536.7, filed on Jun. 7, 2021. The entirety of the above-mentioned patent application is hereby incorporated by reference herein and made a part of this specification.

### TECHNICAL FIELD

The present invention relates to the field of intelligent networked & collaborative manufacturing of a manufacturing industry, in particularly to a constructing method on the intelligent networked manufacturing mode with human-cyber-physical collaboration and fusion for the non-ferrous metal industry.

### BACKGROUND

Non-ferrous metal is a basic raw material and a strategic material for the development of national economy and national defense military industry. The non-ferrous metal industry, as a significant part of a process industry, is an important support for a manufacturing power with an extremely important strategic position and strong development momentum. At present, the principle technology and equipment of non-ferrous metal metallurgy have formed a relatively complete modern non-ferrous metal industrial system.

However, there are still these problems in the current non-ferrous metal industrial manufacturing: multiple non-ferrous metal metallurgy processes, long processes, inter-process correlation coupling, separation of manufacturing information, disconnection of production, supply and marketing, and separation of management and control, thereby making the need for fine management and control of the process with cost, efficiency, quality and safety as the core highlighted, and directly affecting the production efficiency, energy consumption, material consumption and pollutant emissions of non-ferrous metal metallurgy. In addition, non-ferrous metal products are stable in type, serious in homogeneity, and unable to access to the network and be embedded with artificial intelligence technology. Through industry upgrading and digital transformation, an intelligent networked service platform can be constructed, such that the supply of products is transformed into the supply of products and services. The current value adding of products of enterprises mainly relies on low value-added links such as production and processing. These problems are involved in not only manufacturing systems, but also product service systems and business modes. To systemically and comprehensively solve these problems, it is necessary to consider how to perform digital transformation and industry upgrading from the perspective of a manufacturing mode.

The development of information technology affects changes in a manufacturing mode. In the current digital economy era, technologies, such as a new generation of artificial intelligence, the Internet of Things, cloud computing, and big data, are deeply integrated with the non-ferrous metal industry, and industrial reforms are accelerating the transformation of economic development, which provides a major opportunity for the non-ferrous metal industry to breed a new intelligent manufacturing mode with human-cyber-physical collaboration and fusion. The new manufacturing mode can solve the above problems and bring new development opportunities to enterprises.

### SUMMARY OF THE DISCLOSURE

The purpose of the present invention is to provide a constructing method of intelligent networked manufacturing mode with human-cyber-physical collaboration and fusion for the non-ferrous metal industry network so as to overcome defects of low production efficiency of manufacturing systems, low resource and energy utilization rate, highlighted environmental protection problem, serious product homogeneity, and low added value existing in the prior art.

The purpose of the present invention may be achieved by the following technical solution.

The constructing method of an intelligent networked manufacturing mode with human-cyber-physical collaboration and fusion for a non-ferrous metal industrial guides production by constructing an intelligent networked manufacturing system with human-cyber-physical collaboration and fusion, an ecosystem service platform, and a sustainable business model. The intelligent networked manufacturing system with human-cyber-physical collaboration and fusion includes a device autonomous control system and a remote management analysis and decision-making system based on a new generation of AI. The device autonomous control system has functions of perception, intelligent analysis and decision-making, and intelligent control. The remote management analysis and decision-making system has functions of ubiquitous perception, real-time analysis, independent decision-making, accurate execution, and learning improvement. The intelligent networked manufacturing system with human-cyber-physical collaboration and fusion includes a human-cyber-physical interaction mechanism, a human-cyber-physical cooperative mechanism, and a human-cyber-physical fusion mechanism.

The function of perception of the device autonomous control system comprises an intelligent perception function and a ubiquitous perception function.

Further, the intelligent perception function is specifically cross-media intelligent perception, and the ubiquitous perception function is specifically real-time perception, multisource perception, heterogeneous perception, and dynamic perception.

The function of intelligent analysis and decision-making of the device autonomous control system comprises self-regulating and self-improving of a control method and model, and the function of intelligent control comprises self-regulating and self-improving of a control strategy.

The remote management analysis and decision-making system based on the new generation of AI has functions of ubiquitous perception, real-time analysis, independent decision-making, accurate execution, and learning improvement.

The remote management analysis and decision-making system has a self-learning function, and the function of real-time analysis comprises classifying, predicting, simulating, and evaluating production and manufacturing based on big data.

A user type of the ecosystem service platform comprises enterprise, enterprise client, and cooperation partner.

A service type of the ecosystem service platform comprises non-ferrous metal product, product service, process service, customized service, and subscription service.

Further, the non-ferrous metal product is a tradition service of the enterprise, comprising main product and auxiliary product.

Further, the product service is a supplement to product distribution, the process service is established on the internal process of the enterprise, and the enterprise provides relevant consulting service to the public.

A type of a sustainable business model canvas comprises an economic business model canvas, an environmental business model canvas, and a social business model canvas.

Further, the economic business model canvas describes value proposition of a company that produces non-ferrous metal from an economic perspective and includes key partner, key activity, value proposition, client relationship, client segment market, key resource, distribution channel, cost structure, and revenue source; the environmental business model canvas describes the influence of the above company on the environment from an environmental perspective and comprises supply and outsourcing, production, functional value, product processing method, use stage, raw material, distribution method, environmental influence, and environmental benefit; and the social business model canvas describes the mutual influence between company stakeholders and the company and comprises local community, management method, social value, social culture, end user, employee, expansion scale, social influence, and social benefit.

Compared with the prior art, the present invention has the following beneficial effects: the constructing method on the intelligent networked manufacturing mode with human-cyber-physical collaboration and fusion for a non-ferrous metal industry provided herein guides production and manufacturing activities by constructing an intelligent manufacturing system with human-cyber-physical collaboration and fusion, an ecosystem service platform, and a sustainable business mode, and may solve the problems of low production efficiency of non-ferrous metal industry manufacturing systems, low resource and energy utilization rates, and highlighted environmental problems in the non-ferrous metal industry, serious homogeneity and low added value of non-ferrous metal industrial products, as well as unsustainable development of a non-ferrous metal industry business mode, etc. The present invention supports, but is not limited to, a non-ferrous metal industry manufacturing mode and structure and can play a great role in guiding and promoting manufacturing mode transformation and intelligent manufacturing development of other enterprises in the manufacturing industry.

### BRIEF DESCRIPTION OF THE DRAWINGS

FIG. 1 is a structure diagram of the present invention.

FIG. 2 is a structure diagram of a framework of an intelligent manufacturing system with human-cyber-physical collaboration and fusion in an example of the present invention.

FIG. 3 is a structure diagram of an ecosystem service platform in an example of the present invention.

FIG. 4 is a structure diagram of an economic business mode canvas in an example of the present invention.

FIG. 5 is a structure diagram of an environmental business mode canvas in an example of the present invention.

FIG. 6 is a structure diagram of a social business mode canvas in an example of the present invention.

### DETAILED DESCRIPTION OF THE EMBODIMENTS

The present invention will be described in detail with reference to the accompanying figures and specific examples hereinafter. The present example is implemented on the premise of the technical solution of the present invention and provides detailed embodiments and specific operation procedures, while the protection scope of the present invention is not limited to the following example.

### Example

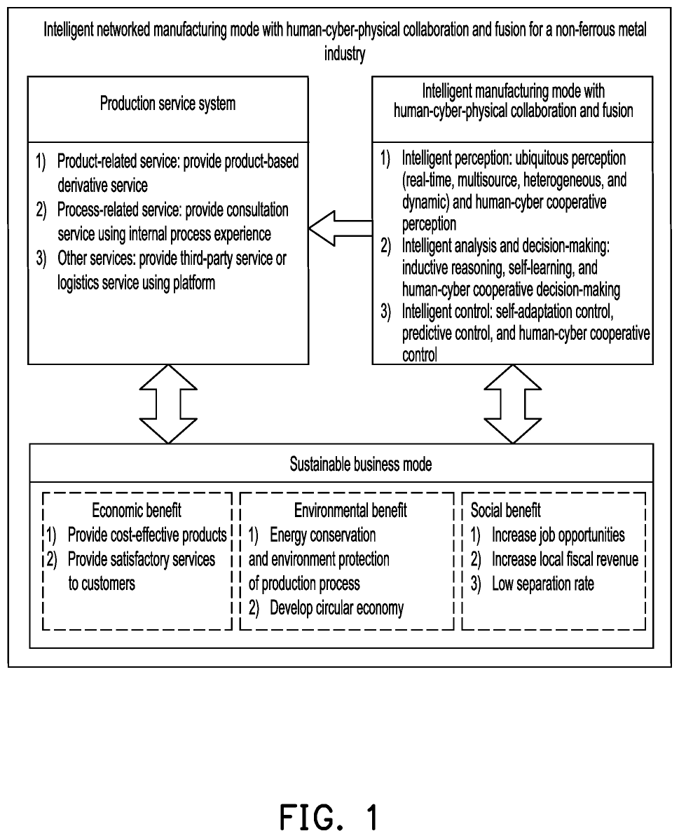

As shown in FIG. 1, a constructing method on the intelligent networked manufacturing mode with human-cyber-physical collaboration and fusion for a non-ferrous metal industrial performs production and manufacturing by constructing an intelligent manufacturing system with human-cyber-physical collaboration and fusion, an ecosystem service platform, and a sustainable business model according to a preset green, efficient, and sustainable goal. The intelligent manufacturing system with human-cyber-physical collaboration and fusion includes a device autonomous control system and a remote management analysis and decision-making system. The device autonomous control system has functions of perception, intelligent analysis and decision-making and independent control. The remote management analysis and decision-making system has functions of ubiquitous perception, real-time analysis, independent decision-making and accurate execution, and learning improvement. The intelligent manufacturing system with human-cyber-physical collaboration and fusion includes a human-cyber-physical interaction mechanism, a human-cyber-physical cooperative mechanism, and a human-cyber-physical fusion mechanism.

The function of perception of the device autonomous control system comprises an intelligent perception function and a ubiquitous perception function.

The intelligent perception function is specifically cross-media intelligent perception, and the ubiquitous perception function is specifically real-time perception, multisource perception, heterogeneous perception, and dynamic perception.

The function of analysis and decision-making of the device autonomous control system comprises self-regulating and self-improving of a control method and model, and the function of intelligent control comprises self-regulating and self-improving of a control strategy. The function of independent control comprises self-regulating and self-improving of a control strategy.

The remote management analysis and decision-making system based on the new generation of AI has functions of ubiquitous perception, real-time analysis, independent decision-making, accurate execution, and learning improvement.

The function of independent decision-making of the remote management analysis and decision-making system has a self-learning function, and the function of real-time analysis comprises classifying, predicting, simulating, and evaluating production and manufacturing based on big data.

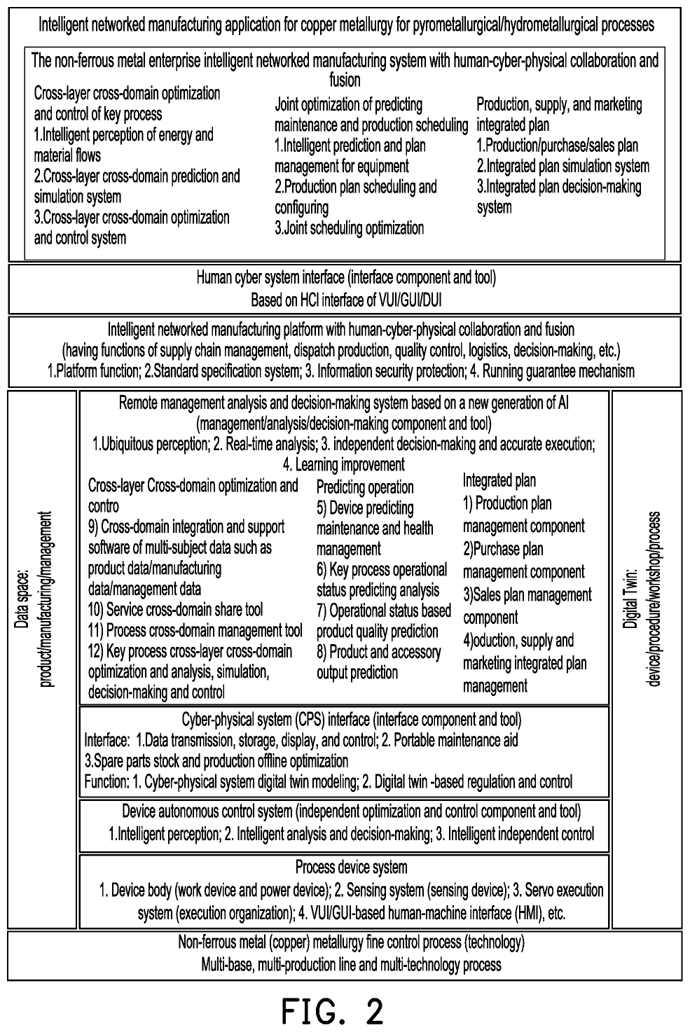

FIG. 2 illustrates intelligent networked manufacturing platform corresponding to intelligent manufacturing system with human-cyber-physical collaboration and fusion in an example of the present invention, comprising a non-ferrous metal metallurgy (copper) fine control process (technology), a process device system, a device autonomous control system, a cyber-physical system (CPS) interface, and a remote management analysis and decision-making system based on a new generation of artificial intelligence.

The fine control process includes a multi-base, multi-production line and multi-technology process. The device autonomous control system has functions of intelligent perception, intelligent analysis and decision-making, and intelligent independent control. The remote management analysis and decision-making system based on the new generation of artificial intelligence has functions of cross-layer cross-domain optimization and control, operation prediction, and integrated planning. The cross-layer cross-domain optimization and control includes cross-domain integration and support software of multi-subject data such as product data/manufacturing data/management data, service cross-domain sharing tool, process cross-domain management tool, key process cross-layer cross-domain optimization analysis, simulation, control, and decision-making. The operation prediction comprises device predictability maintenance and health management, key process operational status prediction analysis, operational status based product quality prediction, and product and accessory output prediction. The integrated planning comprises production plan management component, purchase plan management component, sales plan management component, and production, supply and marketing integrated plan management.

A user type of the ecosystem service platform comprises enterprise, enterprise client, and cooperation partner. The cooperation partner is a subject besides the enterprise that can provide services to the client.

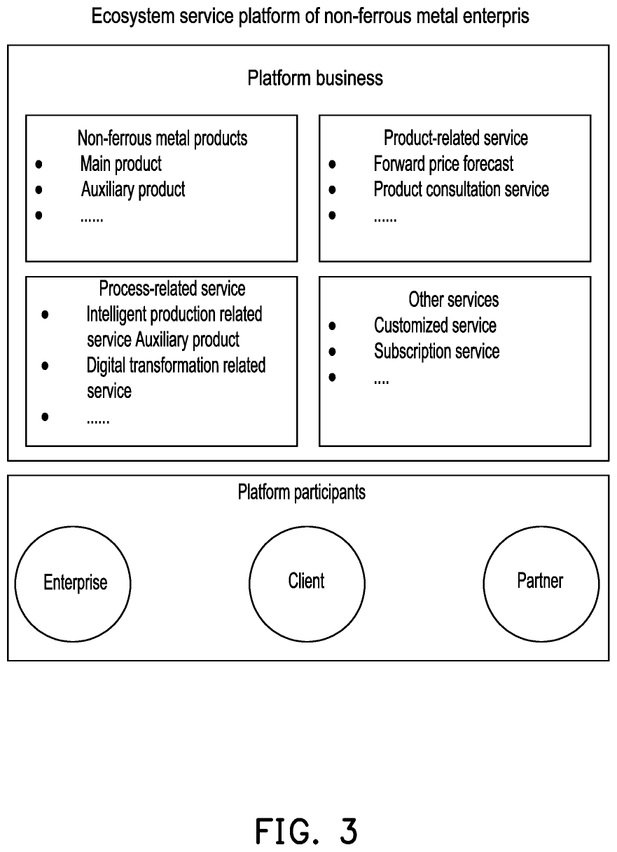

As shown in FIG. 3, a service type of the ecosystem service platform comprises non-ferrous metal product, product service, process service, and other services that include customized service and subscription service.

The non-ferrous metal product is a traditional service of the enterprise, comprising main product and auxiliary product.

The product service is a supplement to product sales. Copper product itself is futures. It is a common demand for clients to predict its price. The enterprise can also provide product-related consulting service based on product experience. The process service is established on the internal process of the enterprise, and the enterprise provides relevant consulting service to the public.

A type of a sustainable business model canvas comprises an economic business model canvas, an environmental business model canvas, and a social business model canvas.

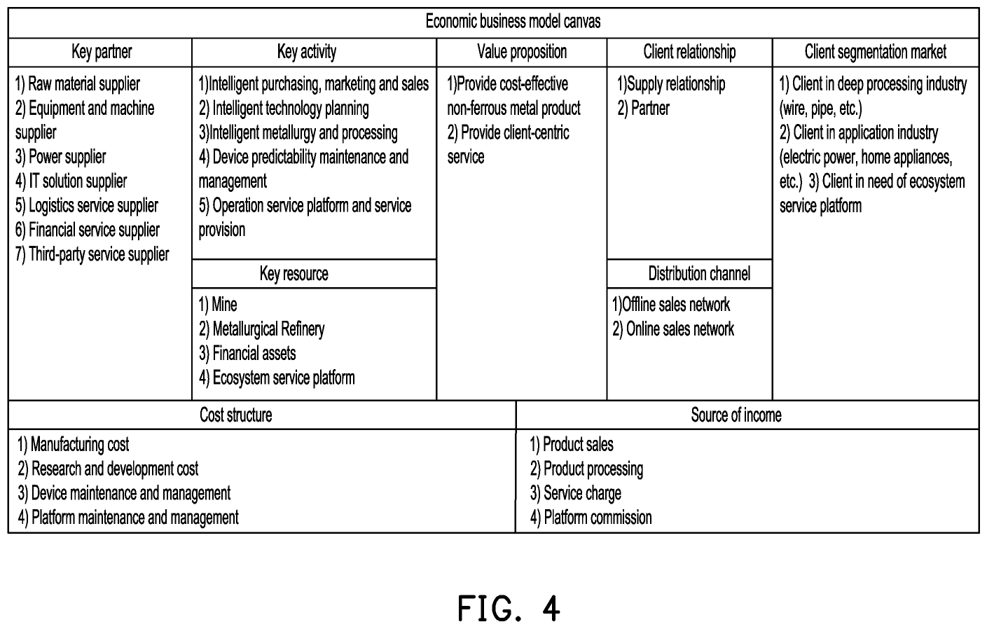

In this example, FIG. 4 shows an economic business model canvas describing value proposition of a company that produces non-ferrous metal from an economic perspective and including key partner, key activity, value proposition, client relationship, client segment market, key resource, distribution channel, cost structure, and revenue source.

Third-party service providers are added as the company's main partner, and the company's ecosystem service platform can attract third-party service providers to settle in. The company and third parties jointly provide client-centric services, and the demander for service can cover the company's upstream and downstream. In terms of main activities, due to the introduction of human-cyber-physical fusion enabling technology, the company's production, supply and marketing activities can be subjected to integrated optimization and decision-making, technological process is subjected to cross-layer cross-domain optimization and control, and production devices are subjected to predictability maintenance and management, thereby reducing the company's production cost and improving production efficiency. In terms of major resources, an ecosystem service platform has been added. In terms of value proposition, client-centric service is added. The platform's third-party service provider and the platform are in partnership. The company's revenue will not be limited to non-ferrous metal product sales and processing fees, and the ecosystem service platform will bring service fees and commission income to the company.

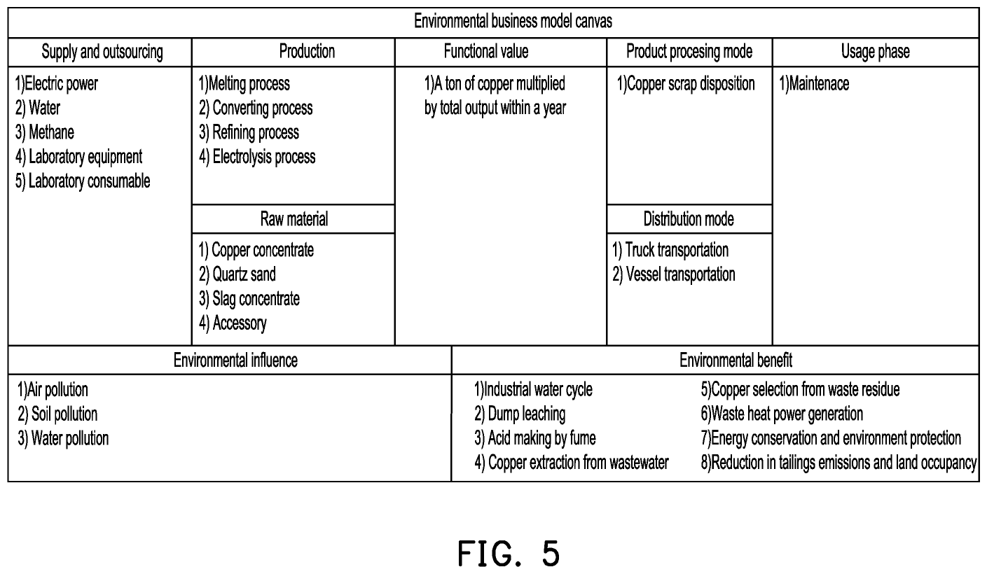

In this example, FIG. 5 illustrates an environmental business model canvas describing the influence of the above company on the environment from an environmental perspective and comprising supply and outsourcing, production, functional value, product processing method, use stage, raw material, distribution method, environmental influence and environmental benefit.

The entire life cycle of a product is analyzed from the perspective of product life cycle assessment (LCA). It is used to indicate environmental benefit of the company on the road to sustainable development and the influence of a product on the environment during the life cycle. Through this model, sustainable practices of the company in energy conservation, environmental protection, and circular economy can be understood. The functional value corresponds to an inspection object of the company in the environmental layer canvas and examines the influence of copper output of the company within a year on the environment. The sustainable practices driven by the human-cyber-physical fusion enabling technology have brought the following benefits in terms of energy saving, environmental protection and circular economy.

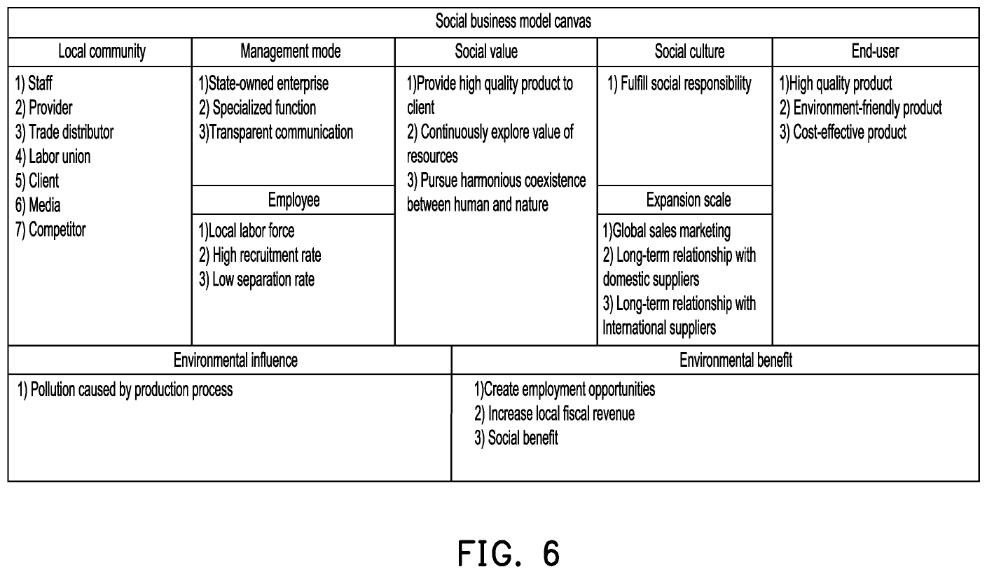

In this example, FIG. 6 illustrates a social business model canvas describing the mutual influence between company stakeholders and the company and comprising local community, management method, social value, social culture, end user, employee, expansion scale, social influence, and social benefit.

The purpose of the canvas model is to investigate the mutual influence between company stakeholders and the company to capture the social influence produced by these key relationships. The social value generated by the company includes providing clients with high-quality products, continuously tapping the value of resources, and pursuing the harmonious coexistence between human and nature. The human-cyber-physical fusion manufacturing system can bring high-quality, environmentally friendly and cost-effective products, and the ecosystem service platform can create more employment opportunities and increase local fiscal revenue.

In addition, it should be explained that the titles of the specific examples described in the present description may be different, and the above content described in the present description is merely an illustration of the structure of the present invention. Equivalent changes or simple changes made according to the structure, features and principles of the concept of the present invention are all included in the protection scope of the present invention. Those skilled in the technical field to which the present invention pertains can make various amendments or additions to the specific examples described or adopt similar methods, which all fall within the protection scope of the present invention as long as they do not deviate from the structure of the present invention or exceed the scope defined by the claims.

What is claimed is:

1. The constructing method on the intelligent networked manufacturing mode with human-cyber-physical collaboration and fusion for a non-ferrous metal industry, wherein according to transformational requirements of a non-ferrous metal industry, production and manufacturing activities are guided by constructing an intelligent manufacturing system with human-cyber-physical collaboration and fusion, an ecosystem service platform, and a sustainable business model, the intelligent manufacturing system with human-cyber-physical collaboration and fusion includes a device autonomous control system and a remote management analysis and decision-making system based on a new generation of AI, the device autonomous control system has functions of perception, intelligent analysis and decision-making, and intelligent control, and the remote management analysis and decision-making system has functions of ubiquitous perception, real-time analysis, independent decision-making, and learning improvement.

2. The constructing method on an intelligent network manufacturing system with human-cyber-physical collaboration and fusion for a non-ferrous metal industry according to claim 1, wherein the function of perception of the device autonomous control system comprises an intelligent perception function and a ubiquitous perception function.

3. The constructing method on the intelligent networked manufacturing mode with human-cyber-physical collaboration and fusion for a non-ferrous metal industry according to claim 2, wherein the intelligent perception function is specifically cross-media intelligent perception, and the ubiquitous perception function is specifically real-time perception, multisource perception, heterogeneous perception, and dynamic perception.

4. The constructing method on the intelligent networked manufacturing mode with human-cyber-physical collaboration and fusion for a non-ferrous metal industry according to claim 1, wherein the function of intelligent analysis and decision-making of the device autonomous control system comprises self-regulating and self-improving of a control method and model, and the function of intelligent control comprises self-regulating and self-improving of a control strategy.

5. The constructing method on the intelligent networked manufacturing mode with human-cyber-physical collaboration and fusion for a non-ferrous metal industry according to claim 1, wherein the remote management analysis and decision-making system based on the new generation of AI has functions of ubiquitous perception, real-time analysis, independent decision-making, accurate execution, and learning improvement.

6. The constructing method on the intelligent networked manufacturing mode with human-cyber-physical collaboration and fusion for a non-ferrous metal industry according to claim 1, wherein the function of independent decision-making of the remote management analysis and decision-making system has a self-learning function, and the function of real-time analysis comprises classifying, predicting, simulating, and evaluating production and manufacturing based on big data.

7. The constructing method on the intelligent networked manufacturing mode with human-cyber-physical collaboration and fusion for a non-ferrous metal industry according to claim 1, wherein a user type of the ecosystem service platform comprises enterprise, enterprise client, and cooperation partner.

8. The constructing method on the intelligent networked manufacturing mode with human-cyber-physical collaboration and fusion for a non-ferrous metal industry according to claim 1, wherein a service type of the ecosystem service platform comprises non-ferrous metal product, product service, process service, customized service, and subscription service.

9. The constructing method on the intelligent networked manufacturing mode with human-cyber-physical collaboration and fusion for a non-ferrous metal industry according to claim 1, wherein a type of a sustainable business model canvas comprises an economic business model canvas, an environmental business model canvas, and a social business model canvas.

10. The constructing method on the intelligent networked manufacturing mode with human-cyber-physical collaboration and fusion for a non-ferrous metal industry according to claim 9, wherein the economic business model canvas includes key partner, key activity, value proposition, client relationship, client segment market, key resource, distribution channel, cost structure, and revenue source; the environmental business model canvas comprises supply and outsourcing, production, functional value, product processing method, use stage, raw material, distribution method, environmental influence and environmental benefit; and the social business model canvas comprises local community, management method, social value, social culture, end user, employee, expansion scale, social influence, and social benefit.
